(19) United States
(12) Patent Application Publication
(10) Pub. No.: US 2026/0204722 A1
(43) Pub. Date: Jul. 16, 2026

(54) TERMINAL COVERING FILM, SECONDARY BATTERY COMPRISING TERMINAL COVERING FILM, AND METHOD FOR MANUFACTURING SECONDARY BATTERY

(71) Applicant: SAMSUNG SDI CO., LTD., Yongin-si (KR)

(72) Inventors: Jeawoan LEE, Yongin-si (KR); Inseop BYUN, Yongin-si (KR); Byunghuy CHO, Yongin-si (KR); Hyojin LIM, Yongin-si (KR); Soyun KIM, Yongin-si (KR); Junho BYEON, Yongin-si (KR)

(21) Appl. No.: 19/282,088

(22) Filed: Jul. 28, 2025

(30) Foreign Application Priority Data
Jan. 10, 2025 (KR) 10-2025-0003927

(51) Int. Cl. H01M 50/342; H01M 50/188; H01M 50/193; H01M 50/197; H01M 50/198

(52) U.S. Cl. CPC H01M 50/342; H01M 50/188; H01M 50/193; H01M 50/197; H01M 50/198; H01M 2200/10

(57) ABSTRACT

A terminal covering film for an electrode terminal of a secondary battery. The terminal covering film includes an outermost layer contacting a case of the secondary battery, an innermost layer contacting the electrode terminal, and an intermediate layer disposed between the outermost layer and the innermost layer, wherein wherein a melting point of the innermost layer is less than a melting point of the outermost layer and less than a melting point of the intermediate layer, and wherein a thickness of the innermost layer is less than a thickness of the outermost layer.

### CROSS-REFERENCE TO RELATED APPLICATION

This application claims priority to and the benefit of Korean Patent Application No. 10-2025-0003927, filed on Jan. 10, 2025, in the Korean Intellectual Property Office, the entire disclosure of which is hereby incorporated by reference.

### BACKGROUND

### 1. Field

The present disclosure relates to a terminal covering film, a secondary battery comprising the terminal covering film, and a method for manufacturing a secondary battery.

### 2. Description of the Related Art

While primary batteries are not designed to be (re)charged, secondary (also known as rechargeable) batteries are batteries that are designed to be discharged and recharged. Among secondary batteries, low-capacity secondary batteries are widely used in portable, small electronic devices, such as smart phones, feature phones, notebook computers, digital cameras, and camcorders, while high-capacity secondary batteries are widely used as power sources for driving motors in hybrid vehicles and electric vehicles, as well as for storing power (e.g., home and/or utility scale power storage). A secondary battery generally includes an electrode assembly including a positive electrode and a negative electrode, a case accommodating both electrodes, and electrode terminals connected to the electrode assembly.

Among secondary batteries, lithium-ion secondary batteries have been widely used. However, lithium-ion secondary batteries are prone to internal gas generation due to cell degradation when continuously left unused or used at a high temperature or charged or discharged at a high current. Such a generation of internal gas can further degrade cell performance. Furthermore, as the internal gas increases the internal pressure of the case, the cell exterior may be deformed or the internal electrode assembly may be damaged, thereby creating an ignition risk.

In some types of secondary batteries, vent components are arranged in the interior to avoid such problems. A vent component functions to eject the internally generated gas to the external environment when the case reaches a certain pressure. However, in other types of secondary batteries, such vent components may not be suitable due to material or structural constraints.

Efforts have been made to suppress generation of the internal gas in secondary batteries, to rapidly detect the internal gas, or to safely and efficiently discharge the internal gas.

This Background section is for the general understanding of the background of the present disclosure, and therefore, it may contain information that does not constitute related (or prior) art.

### SUMMARY

The present disclosure is related to a terminal covering film, a secondary battery comprising the terminal covering filma, and a method for manufacturing a secondary battery.

Embodiments of the present disclosure provide a terminal covering film for covering an electrode terminal of a secondary battery including an outermost layer contacting a case of the secondary battery, an innermost layer contacting the electrode terminal of the secondary battery, and an intermediate layer disposed between the outermost layer and the innermost layer, wherein a melting point of the innermost layer is lower than melting points of the outermost layer and the intermediate layer, and a thickness of the innermost layer is thinner than a thickness of the outermost layer.

Embodiments of the present disclosure provide a terminal covering film for an electrode terminal of a secondary battery, the terminal covering film including: an outermost layer configured to contact a case of the secondary battery; an innermost layer configured to contact the electrode terminal; and an intermediate layer disposed between the outermost layer and the innermost layer, wherein a melting point of the innermost layer is less than a melting point of the outermost layer and less than a melting point of the intermediate layer, and wherein a thickness of the innermost layer is less than a thickness of the outermost layer.

In some embodiments, the thickness of the innermost layer may be from about 13 μm to about 27 μm.

In some embodiments, the innermost layer may be melted at a predetermined temperature range to form a flow path connecting an interior of the case to an exterior of the case.

In some embodiments, upon melting of the innermost layer, a flow path is created connecting an interior of the case to an exterior of the case.

In some embodiments, a melting point of the intermediate layer may be higher than melting points of the outermost layer and the innermost layer.

In some embodiments, the melting point of the intermediate layer is greater than than the melting point of the outermost layer and greater than the melting point of the innermost layer.

In some embodiments, a melting point of the outermost layer may be higher than a melting point of the innermost layer and lower than a melting point of the intermediate layer.

In some embodiments, the melting point of the outermost layer is greater than the melting point of the innermost layer and less than the melting point of the intermediate layer.

In some embodiments, the melting point of the innermost layer may be from about 100° C. to about 125° C.

In some embodiments, the melting point of the outermost layer may be from about 130° C. to about 140° C.

In some embodiments, the melting point of the intermediate layer may be from about 155° C. to about 180° C.

In some embodiments, the innermost layer may include polyethylene, modified polyethylene, casted polypropylene, or mixtures thereof.

In some embodiments, the outermost layer may include polyethylene, casted polypropylene, or mixtures thereof.

In some embodiments, the intermediate layer may include polyurethane, polypropylene, polyethylene terephthalate, or mixtures thereof.

In some embodiments, the intermediate layer may include a heat-resistant material.

Embodiments of the present disclosure provide a secondary battery including an electrode assembly may include at least one electrode terminal, a case accommodating the electrode assembly, the at least one electrode terminal being exposed externally, and at least one terminal covering film covering the at least one electrode terminal, wherein the terminal covering film includes an outermost layer contacting the case, an innermost layer contacting the electrode terminal, and an intermediate layer disposed between the outermost layer and the innermost layer, wherein a melting point of the innermost layer is lower than melting points of the outermost layer and the intermediate layer, and a thickness of the innermost layer is thinner than a thickness of the outermost layer.

Embodiments of the present disclosure provide a secondary battery including: an electrode assembly including an electrode terminal; a case accommodating the electrode assembly, a portion of the electrode terminal being exposed externally; and a terminal covering film covering the electrode terminal, wherein the terminal covering film includes: an outermost layer contacting the case; an innermost layer contacting the electrode terminal; and an intermediate layer disposed between the outermost layer and the innermost layer, wherein a melting point of the innermost layer is less than a melting point of the outermost layer and less than a melting point of the intermediate layer, and wherein a thickness of the innermost layer is less than a thickness of the outermost layer.

In some embodiments, the terminal covering film may be attached to the case and the electrode terminal to seal between the case and the electrode terminal.

In some embodiments, the terminal covering film seals the case and the electrode terminal.

In some embodiments, an inner circumferential surface of the innermost layer may be in surface contact with an outer circumferential surface of the electrode terminal.

In some embodiments, an inner surface of the innermost layer is in contact with an outer surface of the electrode terminal.

In some embodiments, the thickness of the innermost layer may be from about 13 μm to about 27 μm.

In some embodiments, the innermost layer may be melted at a predetermined temperature range to form a flow path connecting an interior of the case to an exterior of the case.

In some embodiments, upon melting of the innermost layer, a flow path is created connecting an interior of the case to an exterior of the case.

Embodiments of the present disclosure provide a method for manufacturing a secondary battery including preparing an electrode assembly including an electrode terminal and a case having an opening formed on one side of the case, disposing a terminal covering film on at least one surface of the electrode terminal, inserting the electrode assembly through the opening formed on one side of the case, and sealing the case, wherein the terminal covering film may include an outermost layer contacting the case, an innermost layer contacting the electrode terminal, and an intermediate layer disposed between the outermost layer and the innermost layer, wherein a melting point of the innermost layer is lower than melting points of the outermost layer and the intermediate layer, and a thickness of the innermost layer is thinner than a thickness of the outermost layer.

Embodiments of the present disclosure provide a method for manufacturing a secondary battery including: preparing an electrode assembly including an electrode terminal and preparing a case having an opening formed on one side of the case; disposing a terminal covering film on at least one surface of the electrode terminal; inserting the electrode assembly through the opening; and sealing the case, wherein the terminal covering film includes: an outermost layer contacting the case; an innermost layer contacting the electrode terminal; and an intermediate layer disposed between the outermost layer and the innermost layer, wherein a melting point of the innermost layer is less than a melting point of the outermost layer and less than a melting point of the intermediate layer, and wherein a thickness of the innermost layer is less than a thickness of the outermost layer.

In some embodiments, the thickness of the innermost layer may be from about 13 μm to about 27 μm.

In some embodiments, during sealing of the case, the innermost layer may be melted and at least a portion of the innermost layer may remain, and an inner circumferential surface of the innermost layer may be in surface contact with an outer circumferential surface of the electrode terminal. According to an embodiment, during sealing of the case, the innermost layer may melt such that at least a portion remains, and an inner circumferential surface of the innermost layer may be in surface contact with an outer circumferential surface of the electrode terminal.

In some embodiments, in the sealing, at least a portion of the innermost layer melts and at least a portion of the innermost layer does not melt, and an inner surface of the innermost layer is in contact with an outer surface of the electrode terminal.

According to some embodiments of the present disclosure, a secondary battery facilitating discharge of internal gas and a terminal covering film for covering an electrode terminal of the secondary battery may be provided.

According to some embodiments of the present disclosure, when an internal or external temperature of a secondary battery rises to a predetermined temperature or higher, a terminal covering film having layers that contact the case of the secondary battery and melt may be provided. Consequently, release of the sealing between the case and the electrode terminal may occur rapidly in hazardous conditions, thereby preventing explosion and ignition of the secondary battery in advance.

According to some embodiments of the present disclosure, by using a terminal covering film combining a low melting point material and a high melting point material, the secondary battery may be sealed at temperatures below the low melting point, and gas generated inside the secondary battery may be discharged to the outside at temperatures at or above the low melting point. Accordingly, sudden increases in internal pressure and deformation of components of the secondary battery may be prevented, thereby preventing internal short circuits between electrode terminals of the secondary battery.

According to some embodiments of the present disclosure, during a thermal exposure stability heating test of a secondary battery, part of the terminal covering film may melt, and gas generated inside the case may be discharged to the outside. Therefore, expansion or rupture of the case due to gas generation during the thermal exposure stability heating test may be prevented, enabling the test to be performed stably.

According to some embodiments of the present disclosure, by forming the innermost layer with a thickness of from about 13 μm to about 27 μm, even if a portion of the innermost layer melts during sealing of the case, at least a portion thereof may remain, thereby maintaining sealing between the case and the electrode terminal. Accordingly, issues such as electrolyte leakage from the secondary battery may be prevented.

### BRIEF DESCRIPTION OF THE DRAWINGS

The drawings illustrate embodiments of the present disclosure, and further describe aspects and features of the present disclosure along with the detailed description of the present disclosure. Thus, the present disclosure should not be construed as being limited to the drawings.

FIG. 1 is an exploded perspective view illustrating a part of a secondary battery according to an embodiment of the present disclosure.

FIG. 2 illustrates a plan view of a secondary battery according to an embodiment of the present disclosure.

FIG. 3 is a cross-sectional view illustrating the secondary battery of FIG. 2 taken along line X-X′ according to an embodiment of the present disclosure.

FIG. 4 illustrates a plan view of an electrode terminal and a terminal covering film according to an embodiment of the present disclosure.

FIG. 5 is a cross-sectional view illustrating the electrode terminal and the terminal covering film of FIG. 4 taken along line Y-Y′ according to an embodiment of the present disclosure.

FIG. 6 illustrates a schematic plan view of a secondary battery according to an embodiment of the present disclosure.

FIG. 7 is a cross-sectional view illustrating a case of the secondary battery of FIG. 6 taken along line Z-Z′ according to an embodiment of the present disclosure.

FIG. 8 is a cross-sectional view illustrating a case of the secondary battery of FIG. 6 taken along line Z-Z′ and showing partial melting of an innermost layer according to an embodiment of the present disclosure.

FIG. 9 is a cross-sectional view illustrating the remaining unmelted innermost layer of FIG. 8 taken along line Z-Z′ according to an embodiment of the present disclosure.

FIG. 10 is a cross-sectional view illustrating the secondary battery of FIG. 2 taken along line X-X′ before melting of the innermost layer according to an embodiment of the present disclosure.

FIG. 11 is a cross-sectional view illustrating the secondary battery of FIG. 2 taken along line X-X′ and showing gas inside the case being discharged to the outside upon melting of the innermost layer according to an embodiment of the present disclosure.

FIG. 12 is a cross-sectional view illustrating the secondary battery of FIG. 2 taken along line X-X′ and showing the intermediate layer contacting the electrode terminal upon melting of the innermost layer according to an embodiment of the present disclosure.

FIG. 13 illustrates changes in temperature and voltage of a secondary battery versus ambient temperature according to an embodiment of the present disclosure.

FIG. 14 is a flowchart illustrating a method for manufacturing a secondary battery according to an embodiment of the present disclosure.

### DETAILED DESCRIPTION

Embodiments of the present disclosure are described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to be limiting of the present disclosure.

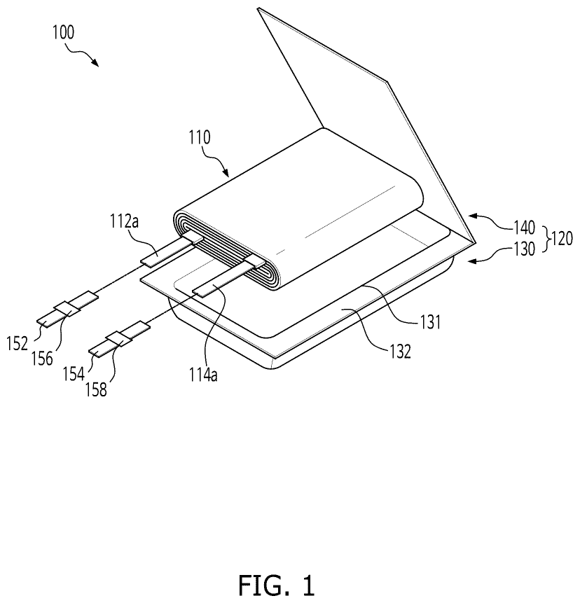

FIG. 1 is an exploded perspective view illustrating a part of a secondary battery.

The secondary battery 100 may include an electrode assembly 110 and a case 120 accommodating the electrode assembly 110.

The electrode assembly 110 may be formed by winding a separator between a first plate and a second plate. However, the present disclosure is not limited thereto, and the electrode assembly 110 may have a stacked structure in which a plurality of sheet-type positive electrodes and negative electrodes are alternately stacked with a separator interposed therebetween.

A positive electrode for a rechargeable lithium battery may include a current collector and a positive electrode active material layer on the current collector. The positive electrode active material layer may include a positive electrode active material and may further include a binder and/or a conductive material(e.g., an electrically conductive material).

For example, the positive electrode may include an additive that can serve as a sacrificial positive electrode.

An amount of the positive electrode active material may be about 90 wt % to about 99.5 wt % based on 100 wt % of the positive electrode active material layer. Amounts of the binder and the conductive material may be about 0.5 wt % to about 5 wt %, respectively, based on 100 wt % of the positive electrode active material layer.

The binder serves to attach the positive electrode active material particles to each other or one another and to attach the positive electrode active material to the current collector. Non-limiting examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, or nylon.

The conductive material may ensure conductivity (e.g., electrical conductivity) to the electrode. Any material that does not cause a detrimental chemical change (e.g., does not cause an undesirable chemical change in the rechargeable lithium battery) while capable of conducting electrons can be used in the battery. Non-limiting examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

Al may be used as the current collector, but is not limited thereto.

The separator may include polyethylene, polypropylene, polyvinylidene fluoride, or a multilayer film of two or more layers thereof, or a mixed multilayer film such as a polyethylene/polypropylene two-layer separator, polyethylene/polypropylene/polyethylene three-layer separator, polypropylene/polyethylene/polypropylene three-layer separator.

The negative electrode for a rechargeable lithium battery may include a current collector and a negative electrode active material layer on the current collector. The negative electrode active material layer may include a negative electrode active material, and may include a binder and/or a conductive material (e.g., an electrically conductive material).

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles to each other or one another and to attach the negative electrode active material to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may include a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, or a combination thereof.

When an aqueous binder is used as the negative electrode binder, a cellulose-based compound capable of providing viscosity may be included. The cellulose-based compound may include carboxymethyl cellulose, hydroxypropylmethyl cellulose, methyl cellulose, or an alkali metal salt thereof. The alkali metal may include Na, K, or Li.

The dry binder may include a polymer material that is fibrous. For example, the dry binder may include polytetrafluoroethylene, polyvinylidene fluoride, a polyvinylidene fluoride-hexafluoropropylene copolymer, polyethylene oxide, or a combination thereof.

The conductive material may ensure conductivity (e.g., electrical conductivity) to the electrode. Any material that does not cause a detrimental chemical change (e.g., does not cause an undesirable chemical change in the rechargeable lithium battery) while capable of conducting electrons can be used in the battery. Non-limiting examples of the conductive material may include a carbon-based material such as natural graphite, artificial graphite, carbon black, acetylene black, ketjen black, a carbon fiber, a carbon nanofiber, or a carbon nanotube; a metal-based material including copper, nickel, aluminum, or silver in a form of a metal powder or a metal fiber; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

The separator may include a porous substrate and a coating layer including an organic material, an inorganic material, or a combination thereof on one or both surfaces of the porous substrate.

The porous substrate may be a polymer film including polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto.

The organic material and the inorganic material may be combined in one coating layer, or a coating layer including an organic material and a coating layer including an inorganic material may be stacked against each other.

The first plate may be a negative electrode plate, and the second plate may be a positive electrode plate; however, the polarities may also be reversed. For example, when the first plate is a negative electrode plate, the negative electrode plate may include a negative current collector made of thin copper foil, and a negative electrode active material layer containing a carbon material as a main component coated on at least one surface of the negative current collector. Negative uncoated regions, which are regions not coated with the negative electrode active material layer, may be formed at both ends of the negative current collector.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may include graphite such as non-shaped, sheet-shaped, flake-shaped, sphere-shaped, or fiber-shaped natural graphite or artificial graphite. The amorphous carbon may include a soft carbon, a hard carbon, a mesophase pitch carbonization product, or calcined coke.

The lithium metal alloy may include lithium and a metal including Na, K, Rb, Cs, Fr, Be, Mg, Ca, Sr, Si, Sb, Pb, In, Zn, Ba, Ra, Ge, Al, or Sn.

The material capable of doping/dedoping lithium may include a Si-based negative electrode active material or a Sn-based negative electrode active material. The Si-based negative electrode active material may include silicon, a silicon-carbon composite, SiOx (0<x<2), or a Si-Q alloy (where Q is selected from an alkali metal, an alkaline-earth metal, a Group 13 element, a Group 14 element (excluding Si), a Group 15 element, a Group 16 element, a transition metal, a rare earth element, or a combination thereof). The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material. When the second plate is a positive electrode plate, the positive electrode plate may include a positive current collector formed of thin aluminum foil, and a positive electrode active material layer containing a lithium-based oxide as a main component coated on at least one surface of the positive current collector. Positive uncoated regions, which are regions not coated with the positive electrode active material layer, may be formed at both ends of the positive current collector.

The positive electrode active material may include a compound (lithiated intercalation compound) that is capable of intercalating and deintercalating lithium. Specifically, a composite oxide of lithium and/or a metal including cobalt, manganese, nickel, or combinations thereof may be used.

The composite oxide may be a lithium transition metal composite oxide. Non-limiting examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

For example, the following compounds represented by any one of the following Chemical Formulas may be used. LiaA1-bXbO2-cDc (0.90≤a≤1.8, 0≤b≤0.5, and 0≤c≤0.05); LiaMn2-bXbO4-cDc (0.90≤a≤1.8, 0≤b≤0.5, and 0≤c≤0.05); LiaNi1-b-cCobXcO2-αDα (0.90≤a≤1.8, 0≤b≤0.5, 0≤c≤0.5, and 0<α<2); LiaNi1-b-cMnbXcO2-αDα (0.90≤a≤1.8, 0≤b≤0.5, 0≤c≤0.5, and 0<α<2); LiaNibCocL1dGeO2(0.90 ≤a≤1.8, 0≤b≤0.9, 0≤c≤0.5, 0≤d≤0.5, and 0≤e≤0.1); LiaNiGbO2(0.90 ≤a≤1.8 and 0.001≤b≤0.1); LiaCoGbO2(0.90 ≤a≤1.8 and 0.001≤b≤0.1); LiaMn1-bGbO2 (0.90≤a≤1.8 and 0.001≤b≤0.1); LiaMn2GbO4(0.90 ≤a≤1.8 and 0.001≤b≤0.1); LiaMn1-gGgPO4 (0.90≤a≤1.8 and 0≤g≤0.5); Li(3-f)Fe2(PO4)3 (0≤f≤2); or LiaFePO4(0.90 ≤a≤1.8).

In the above Chemical Formulas, A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may include, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may achieve relatively high capacity and can be applied to a high-capacity, high-density rechargeable lithium battery.

In the electrode assembly 110, a first electrode tab 112a may be provided at one side of the first plate, and a second electrode tab 114a may be provided at one side of the second plate. The electrode tabs 112a, 114a may be formed by welding tabs to non-coated regions of the first and second plates or by punching out the non-coated regions. In the wound state of the electrode assembly 110, the electrode tabs 112a and 114a may be arranged side by side at a predetermined interval. If the first plate is a negative plate, the first electrode tab 112a may be a negative tab and the second electrode tab 114a may be a positive tab. When the polarities are reversed, the first electrode tab 112a may be a positive tab and the second electrode tab 114a may be a negative tab.

The first electrode tab 112a and the second electrode tab 114a may be coupled with the first electrode terminal 152 and the second electrode terminal 154, respectively, so that the electrode assembly 110 is electrically connected to the outside. As used herein, both the first electrode tab 112a and the second electrode tab 114a are collectively referred to as electrode tabs 112a, 114a, and both the first electrode terminal 152 and the second electrode terminal 154 are collectively referred to as electrode terminals 152, 154.

A part of each electrode terminal 152, 154 may be formed to be exposed outside the case 120. The electrode tabs 112a, 114a and the electrode terminals 152, 154 may include a metal such as aluminum, copper, or nickel. For example, the electrode tabs 112a, 114a and electrode terminals 152, 154 may include a metal with electrical conductivity not less than a predetermined level to minimize voltage drop.

Each electrode terminal 152, 154 may include a terminal covering film 156, 158 on one or both of upper and lower surfaces. For example, the electrode terminals 152, 154 may include terminal covering films 156, 158 attached to regions that contact a sealing portion at an edge of the case 120.

The case 120 forms the overall exterior of the secondary battery 100 and may include a conductive metal such as aluminum, an aluminum alloy, or nickel-plated steel. The case 120 provides an internal space accommodating the electrode assembly 110. According to an embodiment, the case 120 may be a pouch-type case, and the secondary battery 100 may be a pouch-type secondary battery. The case 120 may be a flexible multilayer pouch case. However, the present disclosure is not limited thereto, and the secondary battery 100 may be a prismatic, cylindrical, or other type of battery cell.

According to an embodiment, the case 120 may include an upper case 140 and a lower case 130, which are formed by folding approximately in the center of a generally rectangular case film that is integrally formed along one side in the longitudinal direction. A receiving portion 131 accommodating the electrode assembly 110 may be formed in a generally central region of the lower case 130 by a press. An extension portion 132 may extend in four directions from an upper edge of the receiving portion 131.

The lower case 130 may be coupled to one open end of the upper case 140 to seal the upper case 140. According to an embodiment, one side of the lower case 130 may be open, and the upper case 140 may seal the open side of the lower case 130.

According to an embodiment, the case 120 may include an electrolyte injection port (not shown), for example, a through-hole formed in the case 120. After the upper case 140 is coupled to and sealed with the opening of the lower case 130, an electrolyte injection port may be formed to inject an electrolyte into the case 120. The electrolyte injection port may be sealed by a sealing member after electrolyte injection.

The secondary battery 100 may be a lithium battery cell (e.g., a lithium-ion battery cell) or a sodium battery cell. However, the present disclosure is not limited thereto, and the secondary battery 100 may include any battery capable of repeatedly providing electricity through charging and discharging. In an embodiment, the secondary battery 100 is a lithium battery cell, due to its excellent life characteristics and high-rate performance, and the secondary battery 100 may be used in electric vehicles (EV). The secondary battery 100 may be used in hybrid vehicles, such as plug-in hybrid electric vehicles (PHEV). Lithium battery cells may be used in applications requiring relatively large amounts of power storage, for example, electric bicycles and power tools, but the present disclosure is not limited thereto.

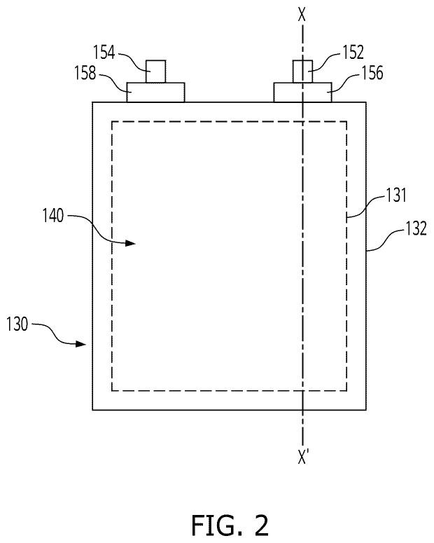

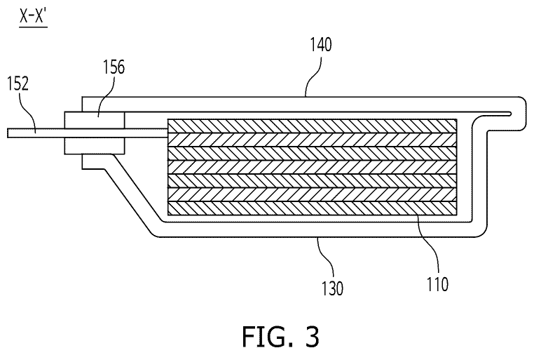

FIG. 2 illustrates a plan view of a secondary battery, and FIG. 3 is a cross-sectional view illustrating the secondary battery of FIG. 2 taken along line X-X′.

According to some embodiments, the secondary battery illustrated in FIGS. 2 and 3 may be substantially the same assembly of components illustrated in FIG. 1. The electrode assembly 110 may be disposed in the receiving portion 131 of the sealed case.

The extension portion 132 of the lower case 130 may be a remaining portion formed when the lower case 130 is pressed to form the receiving portion 131 and may extend away from the receiving portion 131. For example, after the receiving portion 131 accommodates the electrode assembly 110, the extension portion 132 may be sealed by heat-pressing with an edge portion of the upper case 140.

According to an embodiment, at least a portion of each electrode terminal 152, 154 may protrude outside the case. For example, as illustrated in FIG. 2, at least a portion of each electrode terminal 152, 154 may protrude upward beyond the upper ends of the lower case 130 and the upper case 140.

The extension portion 132 may include a sealing surface formed to extend in a direction in which the electrode terminals 152, 154 are drawn out. The sealing surface of the extension portion 132 may correspond to an upper region of the extension portion 132. During sealing of the upper case 140 and the lower case 130, the sealing surface of the extension portion 132 may contact the terminal covering films 156, 158 surrounding the electrode terminals 152, 154.

According to an embodiment, at least a portion of each terminal covering film 156, 158 may protrude outside the case. For example, as illustrated in FIG. 2, at least a portion of each terminal covering film 156, 158 may protrude upward beyond upper ends of the lower case 130 and the upper case 140. However, the present disclosure is not limited thereto, and, for example, a terminal covering film 156, 158 may not be exposed to the exterior of the case.

In some embodiments, the terminal covering films 156, 158 may cover the sealing surfaces of the lower case 130 and the upper case 140. Referring to FIG. 3, a length of the terminal covering film 156 in the drawing-out direction of the electrode terminal 152 (left-right direction in FIG. 3) may be equal to or greater than a length of the sealing surface of the lower case 130 and the upper case 140 in the drawing-out direction. Along the drawing-out direction, a distance between an outer end and an inner end of the electrode terminal 152 may be equal to or greater than a distance between an outer end and an inner end of the extension portion.

According to an embodiment, an outer end of each terminal covering film 156, 158 may be disposed outward of an outer end of the sealing surface, and an inner end of each terminal covering film 156, 158 may be disposed inward of an inner end of the sealing surface. According to an embodiment, the outer end of each terminal covering film 156, 158 may be placed at substantially the same position as the outer end of the sealing surface, and the inner end of each terminal covering film 156, 158 may be disposed inward of the inner end of the sealing surface. In an embodiment, the outer end of each terminal covering film 156, 158 may be disposed inward of the outer end of the sealing surface, and the inner end of each terminal covering film 156, 158 may coincide with the inner end of the sealing surface. In an embodiment, both the outer and inner ends of each terminal covering film 156, 158 are located at substantially the same positions as the outer and inner ends, respectively, of the sealing surface.

According to an embodiment, sealing of the upper case 140 and the lower case 130 may be performed at about about 180° C. to about 220° C. The processing temperature for sealing may be higher than the melting point of the terminal covering films 156, 158. The heating time applied for sealing the upper case 140 and the lower case 130 may be only about 2 s to about 3 s. Because heat is applied for such a relatively short time, melting of the terminal covering films 156, 158 during sealing may be prevented.

The terminal covering films 156, 158 may have shapes and sizes corresponding to the area where the electrode terminals 152, 154 and the lower case 130 and the upper case 140 are in contact. Under normal operating conditions of the secondary battery, the terminal covering films 156, 158 can seal each of the electrode terminals 152, 154, between the lower case 130 and the upper case 140. The terminal covering films 156, 158 can prevent foreign matter from entering into the secondary battery.

Under abnormal conditions or specific environmental conditions, the secondary battery may malfunction and the electrode terminals 152, 154 may become overheated. In such cases, the terminal covering films 156, 158 may melt at least partially due to heat generated by the electrode terminals 152, 154. A gap or micro-channel may form between the lower case 130 and the upper case 140, each of the electrode terminals 152, 154 between the lower case 130, and/or each of the electrode terminals 152, 154 between the upper case 140. The gap or micro-channel may allow internally generated gas to exit. That is, the terminal covering films 156, 158 may function as a safety vent in the sealing region of the lower case 130 and the upper case 140.

A thickness of the terminal covering film 156, 158 (i.e., a vertical distance in FIG. 3) may be substantially the same as the gap between the lower case 130 and the upper case 140, each of the electrode terminals 152, 154 between the lower case 130, and/or each of the electrode terminals 152, 154 between the upper case 140. According to an embodiment, the terminal covering film 156, 158 may initially be formed to be thicker than the gap, and the thickness of the terminal covering film 156, 158 may be partially reduced during the sealing of the case. In an embodiment, the terminal covering film 156, 158 may have substantially the same thickness as the gap between the electrode terminal 152, 154 and the upper case 140 or the gap between the electrode terminal 152, 154 and the lower case 130 before sealing.

According to an embodiment, the electrode terminals 152, 154 may generate more heat than other components of the secondary battery. The terminal covering films 156, 158 may be in direct contact with the electrode terminals 152, 154. In this manner, the terminal covering films 156, 158 may respond relatively quickly to sudden increases in temperature compared to films located in other parts of the battery.

In some embodiments, the lower case 130 or the upper case 140 may include a case film for preventing external damage or for insulation. The case film may be an outermost layer of the lower case 130 or the upper case 140 and may include a metal thin film, an insulating resin, a heat-sealing synthetic resin, or a combination thereof. A substrate (or innermost layer) of the lower case 130 or the upper case 140 may be in contact with the terminal covering films 156, 158. The substrate of the lower case 130 or the upper case 140 may include a material of substantially the same or similar type as those of the terminal covering films 156, 158, thereby increasing the adhesion between the terminal covering films 156, 158 positioned in the sealing region and the case substrates during sealing.

Referring to FIG. 2, the terminal covering films 156, 158 may be on both the first electrode terminal 152 and the second electrode terminal 154. However, the present disclosure is not limited thereto. For example, the terminal covering film may be formed only on one of the first electrode terminal 152 and the second electrode terminal 154. According to an embodiment, the terminal covering film may be formed only on the positive terminal that generates relatively more heat and not on the negative terminal.

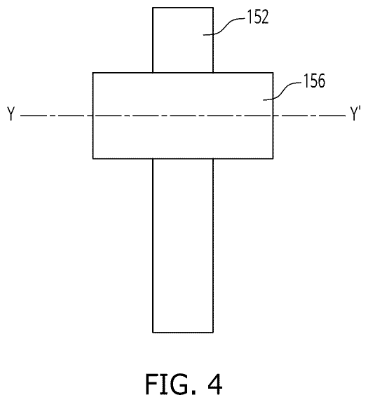

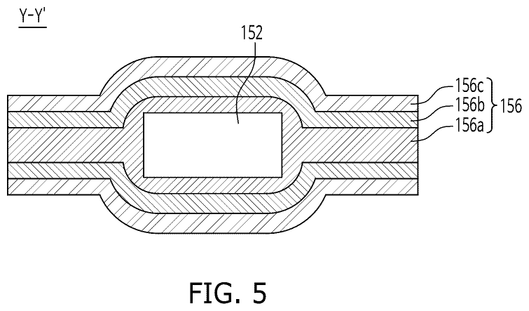

FIG. 4 illustrates a plan view of an electrode terminal and a terminal covering film, and FIG. 5 is a cross-sectional view illustrating the electrode terminal and the terminal covering film of FIG. 4 taken along line Y-Y′.

The terminal covering film 156 may include a plurality of layers. Referring to FIGS. 4 and 5, the terminal covering film 156 may include an outermost layer 156c contacting the case, an innermost layer 156a contacting the electrode terminal 152, and an intermediate layer 156b disposed between the outermost layer 156c and the innermost layer 156a.

According to an embodiment, the melting point of the innermost layer 156a may be lower than the melting points of the outermost layer 156c and the intermediate layer 156b. As the electrode terminal 152 may be overheated under specific conditions, due to the relatively low melting point of the innermost layer 156a, at least a portion of the innermost layer 156a may melt before the intermediate layer 156b and the outermost layer 156c melt. Consequently, a micro-gap or channel may form between the case and the electrode terminal 152, allowing internally generated gas to be discharged to the external environment.

For example, the melting point of the innermost layer 156a may be from about 100° C. to about 125° C. The innermost layer 156 a may include polyethylene, modified polyethylene, casted polypropylene, or mixtures thereof.

According to an embodiment, the innermost layer 156a may include a polyethylene (PE)-based resin. The PE-based resin may have self-combusting properties upon melting. If the electrode terminal 152 generates heat above the melting point of the innermost layer 156a, at least a portion of the innermost layer 156a formed of the PE-based resin may melt then burn, thereby opening a passage that connects the interior and the exterior of the case. Accordingly, internally generated gas may be discharged to the external environment through the burned region of the innermost layer 156a.

In some embodiments, the innermost layer 156a of the terminal covering film 156 may include low-density polyethylene (LDPE), a polyethylene (PE) having a density ranging from about 0.91 g/cm³ to about 0.925 g/cm³. The low-density polyethylene (LDPE) may have a melting point of about 100° C. to about 115° C.

In some embodiments, the innermost layer 156a of the terminal covering film 156 may include a linear low-density polyethylene (LLDPE), a polyethylene (PE) having a density ranging from about 0.926 g/cm³ to about 0.940 g/cm³. The linear low-density polyethylene (LLDPE) may have a melting point of about 115° C. to about 125° C.

According to an embodiment, at least a portion of the innermost layer 156a of the terminal covering film 156 may melt as the temperature of the electrode terminal 152 reaches the melting point. A hollow space may form between the electrode terminal 152 and the intermediate layer 156b of the terminal covering film 156, allowing the internally generated gas to escape.

Referring to FIGS. 4 and 5, the terminal covering film 156 may have a geometry similar to a rectangular parallelepiped with rounded corners; however, the present disclosure is not limited thereto, and geometries such as circular, semicircular, inverted triangular, or polygonal may be employed.

According to an embodiment, melting points of the outermost layer 156c and the intermediate layer 156b may be higher than the melting point of the innermost layer 156a. A melting point of the intermediate layer 156b may be higher than melting points of the outermost layer 156c and the innermost layer 156a. According to some embodiments, a melting point of the outermost layer 156c may be from about 130° C. to about 140° C., and a melting point of the intermediate layer 156b may be from about 155° C. to about 180° C.

According to some embodiments, the outermost layer 156c may include polyethylene, casted polypropylene, or mixtures thereof. The intermediate layer 156b may include polyurethane, polypropylene, polyethylene terephthalate, or mixtures thereof.

In some embodiments, the intermediate layer 156b and the outermost layer 156c of the terminal covering film 156 may each include casted polypropylene (CPP), a heat-sealable synthetic resin derived from polypropylene (PP). Polypropylene-based resins typically have a melting point ranging from about 130° C. to about 171° C.

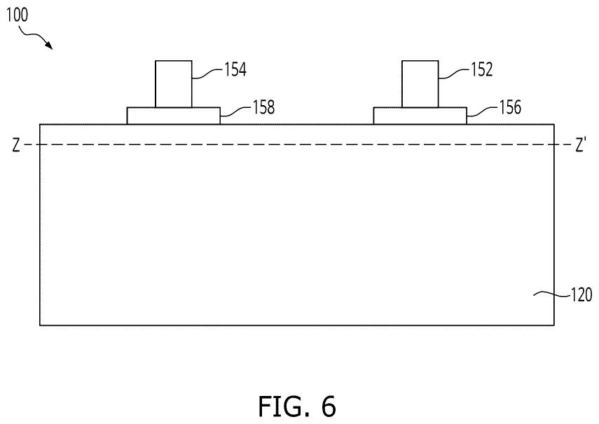

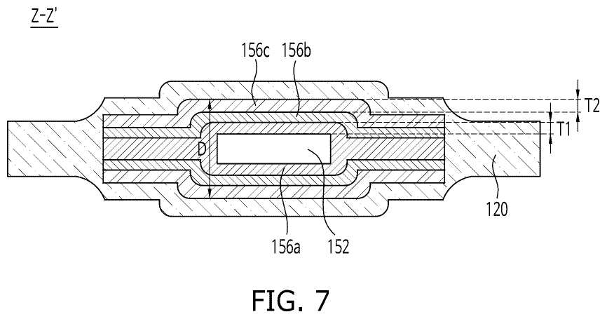

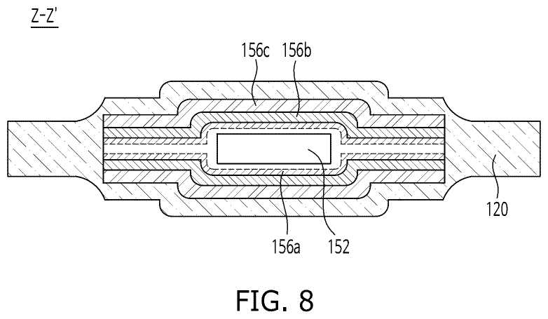

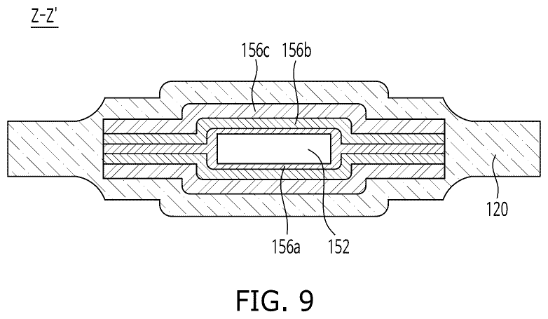

FIG. 6 is a schematic plan view illustrating a secondary battery; FIG. 7 is a cross-sectional view taken along line Z-Z′ of the secondary battery of FIG. 6; FIG. 8 is a cross-sectional view taken along line Z-Z′ of the secondary battery of FIG. 6, illustrating partial melting of the innermost layer; and FIG. 9 is a cross-sectional view taken along line Z-Z′ of FIG. 8, illustrating the remaining unmelted portion of the innermost layer.

The secondary battery 100 may include two terminal covering films 156 and 158, each contacting one of the two electrode terminals 152 and 154, respectively. In some embodiments, the terminal covering film 156 contacting the first electrode terminal 152 may differ from the terminal covering film 158 contacting the second electrode terminal 154 in geometry, length, thickness, cross-sectional profile, or material. The terminal covering film 156 may be substantially identical to the terminal covering film 158.

In an embodiment, the terminal covering films 156 and 158 may fully surround the respective electrode terminals 152 and 154. However, the present disclosure is not limited thereto. For example, the terminal covering films 156 and 158 may partially surround the electrode terminals 152 and 154.

When the electrode terminals 152 and 154 become overheated, the innermost layer 156a of the terminal covering film may melt earlier than the sealing part of the case 120, the intermediate layer 156b, and/or the outermost layer 156c. Such an arrangement may function as a safety vent in the secondary battery 100. By including the innermost layer 156a, risks of explosion or ignition due to overheating of the electrode terminals 152 and 154 during abnormal operation can be prevented or minimized.

For example, the melting point of the innermost layer 156a may be from about 100° C. to about 125° C.

If the melting point of the innermost layer 156 a is less than 100° C., the innermost layer 156 a may melt at a temperature less than 100° C., thereby prematurely releasing the sealing between the case 120 and the electrode terminals 152, 154 and not meeting environmental standards (such as high-temperature high-humidity storage at 85° C.). Therefore, the melting point of the innermost layer 156a that directly contacts the electrode terminals 152, 154 may be equal to or greater than about 100° C.

If the melting point of the innermost layer 156a is greater than 125° C., the innermost layer 156a may not melt at a temperature greater than 125° C. For instance, a heating test conducted at 130° C. may result in excessively strong sealing between the case 120 and the electrode terminals 152, 154, causing internal short circuits due to deformation of the electrode assembly, and leading to fire risks. Therefore, internal gas pressure should preferably be reduced before an internal short circuit occurs. Accordingly, the melting point of the innermost layer 156a may be less than or equal to about 125° C.

The innermost layer 156a may include low-density polyethylene (LDPE), linear low-density polyethylene (LLDPE), polyethylene including ethylene-vinyl-acetate copolymer, modified polyethylene including maleic-anhydride-grafted polyethylene or acrylic-acid-grafted polyethylene, casted polypropylene (CPP), or mixtures thereof.

The intermediate layer 156b may have a melting point of equal to or greater than about 155° C. to provide resistance to temperature variations during sealing of the secondary battery 100. Sealing between the upper and lower cases and between the case 120 and the electrode terminals 152, 154 may be performed at temperatures of about 180° C. to about 220° C. for about 2 to about 3 seconds. Thus, to prevent heat from reaching and melting the innermost layer 156a during sealing, the intermediate layer 156b is capable of blocking heat transfer. Direct contact between the metal layers of the electrode terminals 152, 154 and the metal substrate of the case 120 may cause corrosion, adversely affecting battery safety. Thus, the melting point of the intermediate layer 156b positioned between the innermost layer 156a and the outermost layer 156c may be equal to or greater than about 155° C.

The intermediate layer 156b may include a heat-resistant material. Specifically, the intermediate layer 156b may include polyurethane, polypropylene including casted polypropylene (CPP) or oriented polypropylene (OPP), polyethylene terephthalate (PET), or mixtures thereof.

The outermost layer 156c may have a melting point ranging from about 130° C. to about 140° C. to ensure sealing quality. Sealing between the upper and lower cases and between the case 120 and the electrode terminals 152, 154 may occur at temperatures of approximately about 180° C. to about 220° C. To enhance sealing quality, the melting point of the outermost layer 156c should preferably align closely with that of the casted polypropylene (CPP) layer forming the substrate of the case 120, typically about 140° C.

If the melting point of the outermost layer 156c exceeds 140° C., complete melting of the CPP substrate of the case 120 may happen, deteriorating the uniformity of the terminal covering film 156. Therefore, the melting point of the outermost layer 156c may be less than or equal to about 140° C.

If the melting point of the outermost layer 156c is less than 130° C., excessive melting or excessive heat transfer toward the innermost layer 156a may occur. Hence, the melting point of the outermost layer 156c may be equal to or greater than about 130° C.

Regarding the melting-point characteristics, the outermost layer 156c may include polyethylene including high-density polyethylene (HDPE), casted polypropylene (CPP), or mixtures thereof.

Advantageously, each layer of the terminal covering film 156 enables effective and robust sealing between the terminal covering film 156 and the case 120. Excessive sealing of the electrode terminals 152, 154 can be prevented, and the film can function as a safety vent during heating tests. In some embodiments, each layer of the terminal covering film 156 may include a polymer. The melting points of such polymers may be adjusted according to molecular weight variations, biaxial stretching, absence of stretching, or differences in initial monomers or polymer materials. Polymers may be selected or adjusted to satisfy desired characteristics for forming the terminal covering film 156.

Each of the layers included in the terminal covering film 156 may have various thicknesses. According to an embodiment, a thickness (T₁) of the innermost layer 156a may be less than a thickness (T₂) of the outermost layer 156c. For example, the thickness T₁ may range from about 13 μm to about 27 μm.

If the thickness T₁ of the innermost layer 156a is less than about 13 μm, the innermost layer may completely melt during sealing of the case 120, potentially resulting in electrolyte leakage from the interior. If thickness T₁ is at least 13 μm, only a portion of the innermost layer, defined by the dashed lines in FIG. 8, may melt during sealing, while the remaining portion remains in contact with the electrode terminal 152, thus maintaining the sealed state of the secondary battery, as shown in FIG. 9.

If the thickness T₁ of the innermost layer 156a exceeds about 27 μm, sealing defects may occur during thermal sealing between the electrode terminal 152 and the case 120 due to lifting of the space between the case and the terminal covering film 156. This lifted space may lead to electrolyte leakage. Conversely, when thickness T₁ is less than or equal to 27 μm, no lifted space forms between the case 120 and the terminal covering film 156, as illustrated in FIGS. 7 to 9, thus preventing electrolyte leakage.

According to an embodiment, the thickness T₁ of the innermost layer 156a may be less than the thickness T2 of the outermost layer 156c, enabling the innermost layer 156a to selectively respond to temperature increases of the electrode terminal 152. Internally generated gas may be discharged before the internal pressure adversely affects the secondary battery 100. A thicker outermost layer 156c compared to the innermost layer 156a may prevent excessive heat transfer to the innermost layer 156a during sealing.

According to an embodiment, the spacing D between the upper and lower portions of the case 120 may be substantially equal to the thickness of the terminal covering film surrounding the electrode terminal 152, i.e., the vertical dimension in FIG. 7. In some embodiments, the terminal covering film is initially thicker than spacing D and partially reduced during sealing. In some embodiments, the terminal covering film may be formed substantially equal to spacing D prior to sealing.

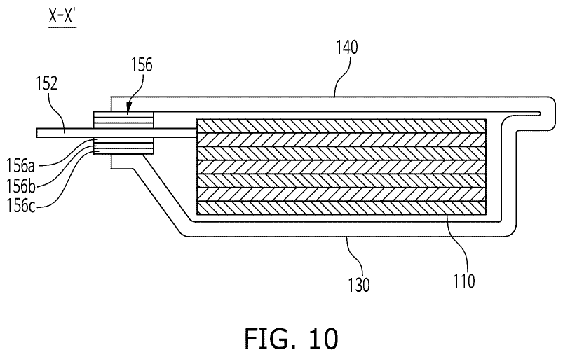

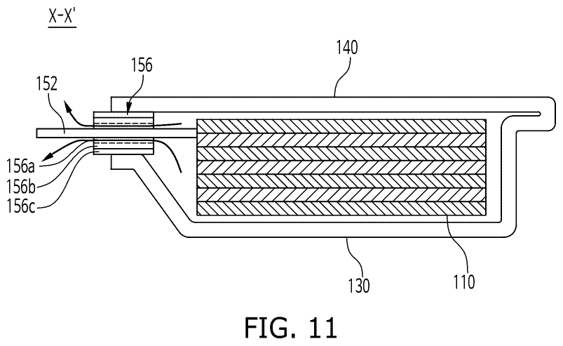

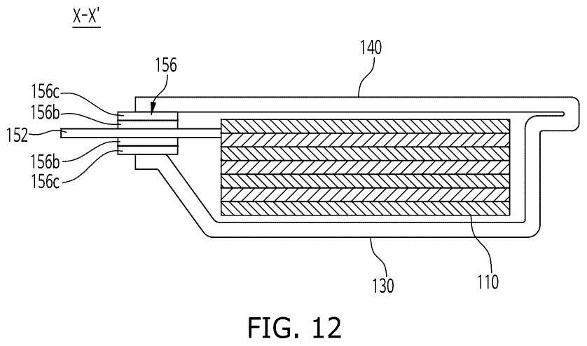

FIG. 10 is a cross-sectional view taken along line X-X′ of the secondary battery shown in FIG. 2, illustrating a state before melting of the innermost layer; FIG. 11 illustrates gas inside the case being discharged externally due to melting of the innermost layer; and FIG. 12 illustrates the intermediate layer contacting the electrode terminal following melting of the innermost layer.

According to an embodiment, the terminal covering film 156 may seal the electrode terminal 152, the upper case 140, and the lower case 130. With the electrode assembly 110 accommodated within the lower case 130, the terminal covering film 156 maintains sealing around the electrode terminal 152, thereby preventing electrolyte leakage, as illustrated in FIG. 10.

A melting point of the innermost layer 156a may be less than the melting points of the outermost layer 156c and the intermediate layer 156b. According to an embodiment, the innermost layer 156a may melt at a temperature in a predetermined temperature range to form a flow path connecting the interior and the exterior of the case. At least a portion of the innermost layer 156a may melt at a temperature in the predetermined temperature range.

According to an embodiment, the melting point of the innermost layer 156a may range from about 100° C. to about 125° C. For example, at least part of the innermost layer may melt before the temperature of the secondary battery or its surroundings reaches about 120° C. Under these conditions, the outermost layer 156c and intermediate layer 156b remain unmelted, forming a path defined by the dashed lines in FIG. 11. Internally generated gas is discharged externally through this path. Gas generated during thermal stability tests may escape through the space formed between the electrode terminal 152 and the intermediate layer 156b.

As illustrated in FIG. 12, the outermost layer 156c and intermediate layer 156b remain intact even when the innermost layer 156a is fully melted, thereby providing insulation to the upper and lower cases 140, 130 and the electrode terminal 152, and maintaining the sealed condition of the secondary battery.

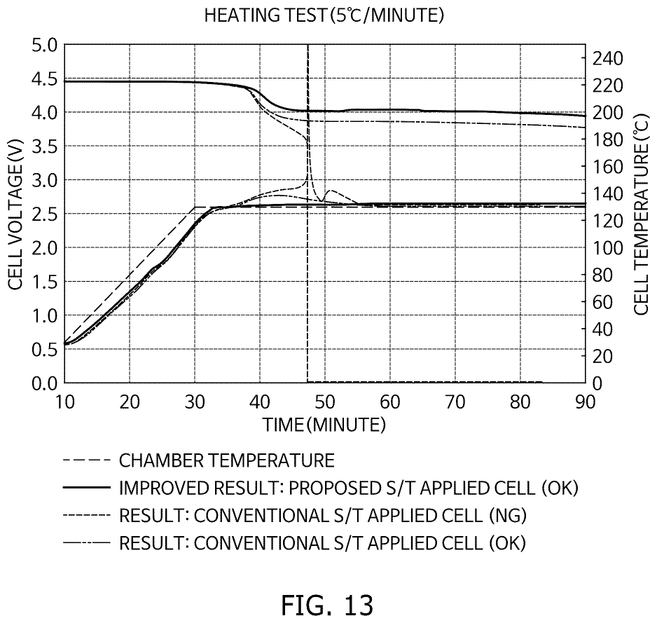

FIG. 13 illustrates changes in temperature and voltage of a secondary battery versus ambient temperature.

FIG. 13 may show heating-test results for various secondary batteries; for example, a heating test may involve placing a test battery in a chamber, increasing the chamber temperature, and recording changes in temperature and voltage of the battery. The chamber temperature may be increased to 130° C. at 5° C./min.

During heating tests, temperature and internal pressure within the secondary battery placed in the chamber may increase. Without proper gas discharge, the internal pressure may cause the case to swell or deform, potentially causing physical deformation of the internal electrode assembly and resulting in a short circuit.

Conventional secondary batteries may exhibit rapid temperature and internal pressure increases, leading to internal short circuits or spontaneous ignition.

In contrast, secondary batteries according to embodiments of the present disclosure exhibit stable temperature and internal pressure conditions because, upon reaching about 100° C. to about 125° C., at least part of the innermost layer of the terminal covering film melts, allowing internal gas to escape externally. Thus, even in cases of rapid or prolonged temperature increases, risks of short circuits and ignition can be mitigated, thereby improving battery safety.

According to some embodiments, the case may take various forms, such as prismatic, pouch-type, or cylindrical. For example, pouch-type batteries are widely used in mobile phones, which often experience rapid temperature increases or prolonged exposure to elevated temperatures during extended use or charging. Thus, safety improvements provided by the present disclosure are particularly valuable for such applications.

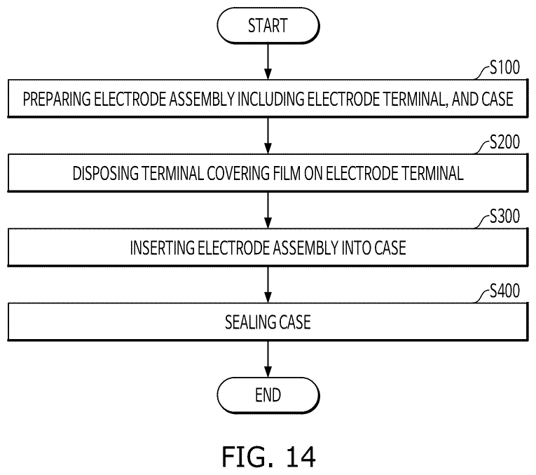

FIG. 14 is a flowchart illustrating a method for manufacturing a secondary battery.

According to an embodiment, the method includes preparing an electrode assembly and a case S100. Referring to FIG. 14, the method may include preparing an electrode assembly and a case S100, disposing a terminal covering film on an electrode terminal S200, inserting the electrode assembly into the case S300, and sealing the case S400.

Preparing the electrode assembly and the case S100 may include preparing an electrode assembly including an electrode terminal and a case having an opening formed on one side thereof. Disposing the terminal covering film on the electrode terminal S200 may include disposing the terminal covering film on at least one surface of the electrode terminal, for example, on both surfaces. The terminal covering film may include an outermost layer, an innermost layer, and an intermediate layer. A melting point of the innermost layer may be lower than melting points of the outermost layer and the intermediate layer, and a thickness of the innermost layer may be thinner than a thickness of the outermost layer, for example, about 13 μm to about 27 μm.

Inserting the electrode assembly into the case S300 may include inserting the electrode assembly through an opening formed on one side of the case. After insertion, sealing the case S400 may be performed.

For example, the step of sealing the case S400 may include sealing by thermal fusion. According to an embodiment, during sealing, the innermost layer melts partially such that a portion remains, ensuring surface contact between the inner surface of the remaining innermost layer and the electrode terminal, thereby maintaining a secure sealed state.

The flowchart of FIG. 14 and the above descriptions are merely exemplary and do not limit the scope of the present disclosure. Steps may be added, modified, omitted, reordered, or performed concurrently.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

What is claimed is:

1. A terminal covering film for an electrode terminal of a secondary battery, the terminal covering film comprising:
an outermost layer configured to contact a case of the secondary battery;
an innermost layer configured to contact the electrode terminal; and
an intermediate layer disposed between the outermost layer and the innermost layer,
wherein a melting point of the innermost layer is less than a melting point of the outermost layer and less than a melting point of the intermediate layer, and
wherein a thickness of the innermost layer is less than a thickness of the outermost layer.

2. The terminal covering film as claimed in claim 1, wherein the thickness of the innermost layer is about 13 μm to about 27 μm.

3. The terminal covering film as claimed in claim 1, wherein, upon melting of the innermost layer, a flow path is created connecting an interior of the case to an exterior of the case.

4. The terminal covering film as claimed in claim 1, wherein the melting point of the intermediate layer is greater than than the melting point of the outermost layer and greater than the melting point of the innermost layer.

5. The terminal covering film as claimed in claim 1, wherein the melting point of the outermost layer is greater than the melting point of the innermost layer and less than the melting point of the intermediate layer.

6. The terminal covering film as claimed in claim 1, wherein the melting point of the innermost layer is about 100° C. to about 125° C.

7. The terminal covering film as claimed in claim 1, wherein the melting point of the outermost layer is about 130° C. to about 140° C.

8. The terminal covering film as claimed in claim 1, wherein the melting point of the intermediate layer is about 155° C. to about 180° C.

9. The terminal covering film as claimed in claim 1, wherein the innermost layer comprises polyethylene, modified polyethylene, casted polypropylene, or mixtures thereof.

10. The terminal covering film as claimed in claim 1, wherein the outermost layer comprises polyethylene, casted polypropylene, or mixtures thereof.

11. The terminal covering film as claimed in claim 1, wherein the intermediate layer comprises polyurethane, polypropylene, polyethylene terephthalate, or mixtures thereof.

12. The terminal covering film as claimed in claim 1, wherein the intermediate layer comprises a heat-resistant material.

13. A secondary battery comprising:
an electrode assembly comprising an electrode terminal;
a case accommodating the electrode assembly, a portion of the electrode terminal being exposed externally; and
a terminal covering film covering the electrode terminal,
wherein the terminal covering film comprises:
an outermost layer contacting the case;
an innermost layer contacting the electrode terminal; and
an intermediate layer disposed between the outermost layer and the innermost layer,
wherein a melting point of the innermost layer is less than a melting point of the outermost layer and less than a melting point of the intermediate layer, and
wherein a thickness of the innermost layer is less than a thickness of the outermost layer.

14. The secondary battery as claimed in claim 13, wherein the terminal covering film seals the case and the electrode terminal.

15. The secondary battery as claimed in claim 14, wherein an inner surface of the innermost layer is in contact with an outer surface of the electrode terminal.

16. The secondary battery as claimed in claim 13, wherein the thickness of the innermost layer is about 13 μm to about 27 μm.

17. The secondary battery as claimed in claim 13, wherein, upon melting of the innermost layer, a flow path is created connecting an interior of the case to an exterior of the case.

18. A method for manufacturing a secondary battery comprising:
preparing an electrode assembly including an electrode terminal and preparing a case having an opening formed on one side of the case;
disposing a terminal covering film on at least one surface of the electrode terminal;
inserting the electrode assembly through the opening; and
sealing the case,
wherein the terminal covering film comprises:
an outermost layer contacting the case;
an innermost layer contacting the electrode terminal; and
an intermediate layer disposed between the outermost layer and the innermost layer,
wherein a melting point of the innermost layer is less than a melting point of the outermost layer and less than a melting point of the intermediate layer, and
wherein a thickness of the innermost layer is less than a thickness of the outermost layer.

19. The method as claimed in claim 18, wherein the thickness of the innermost layer is about 13 μm to about 27 μm.

20. The method as claimed in claim 18, wherein in the sealing, at least a portion of the innermost layer melts and at least a portion of the innermost layer does not melt, and an inner surface of the innermost layer is in contact with an outer surface of the electrode terminal.
